(19) United States
(12) Patent Application Publication
(10) Pub. No.: US 2012/0256499 A1
(43) Pub. Date: Oct. 11, 2012

(54) Brushless Electric Motor

(76) Inventors: Hans Bader, Fahrenback-Robem (DE); Christian Keilbach, Schefflenz (DE)

(21) Appl. No.: 13/437,188

(22) Filed: Apr. 2, 2012

(30) Foreign Application Priority Data
Apr. 6, 2011 (DE) 10 2011 006 893.7

(51) Int. Cl. H02K 5/15; H02K 15/00

(52) U.S. Cl. 310/43; 29/596

(57) ABSTRACT

The invention relates to a brushless electric motor—preferably for a vehicle fan—having an armature which is supported on both sides in a housing, wherein the housing consists substantially of a plastic-containing material and is provided with a preferably substantially tapered casing section as well as two cover sections onto or into both cover sections one bearing each is formed for the armature shaft, and said two cover sections being connected to each other via the casing section and being supported by each other, as well as a stator assembly which extends between the housing casing and the armature wherein the housing is further provided with at least one molded body made of a plastic-containing material for receiving the stator assembly while at the same time determining the axial and radial position, said molded bodies, in turn, being clamped between the cover sections and the casing section in a radial and axial direction, and in this way reinforcing the housing.

### TECHNICAL FIELD

The invention relates to a brushless electric motor as used, for instance, as a fan motor for vehicles such as cabin scooters, buses or other large capacity vehicles as well as to a housing for such a brushless electric motor as well as to a method of producing such a brushless electric motor.

### CROSS-REFERENCE TO RELATED APPLICATIONS

This application claims foreign priority benefits under 35 U.S.C. .§.119 to German Patent Application No. 10 2011 006 893.7 filed on Apr. 6, 2011 the entire contents of which are hereby incorporated by reference.

### BACKGROUND OF THE INVENTION

Brushless electric motors have long been known in drive technology and have stood the test of time as they are highly reliable, durable and hardwearing and as they can do without sliding contacts and mechanical commutators. Furthermore, they can achieve higher efficiencies and the danger of fire caused by sparks due to brush sparking does not apply.

Thus, DE 1 233 480 B1 describes a brushless direct current motor in a flat belly shape having a stationary iron armature containing a stack of sheets and a bell-shaped external rotor with a permanent magnet whose elements which control the commutation are attached in a radially displaced manner within the axial length of the permanent magnet on stationary components.

DE 127 67 99 B1 relates to a direct current motor with a permanent magnet rotor whose commutator is provided with electronic elements for commutation instead of mechanical contacts that have been used up to now. The coils of the motor which are disposed in the stator are controlled and fed via transistors depending on the position of the rotor. The electric permeability of the transistors is controlled by a ferromagnetic control element which rotates with the rotor.

Usually, brushless electric motors consist of a plurality of functional components which have to be assembled and installed in a relatively complicated manufacturing process wherein typically metallic materials were used for all load-bearing elements and drive elements and only coils were provided with insulation elements consisting of plastic material. These functional components will then conventionally be incorporated into a cast housing made of an iron or aluminum material which also supports the bearings for the armature shaft.

For several decades, plastic materials have been used increasingly due to their insulation properties as well as for cost-saving and weight-reduction reasons whereas in relatively small low-power motors plastic housings were used instead of metal housings.

DE 423 28 50 A1 shows a flat, brushless electric motor for small fans with a permanent magnet rotor which is provided with a ring-shaped polyaxially magnetised rotor magnet and a stator which is provided with at least one flat coil for an ironless stator winding which is penetrated by the magnetic field of the rotor magnet which acts axially. The rotor which is built as a permanent magnet rotor is supported in a support tube via a rotor axis which tube is attached to a cover made of a plastic material.

DE 10 2007 046 227 A1 proposes a brushless electric motor with a rotor module, with a stator module and with a plurality of coils whereas the stator module is produced at least partially by a so-called MID technology (Mulded Interconnected Device) and whereas the stator module is provided with fixing elements for fixing the plurality of coils to the stator module.

DE 10 339 621 A1 discloses a brushless electric motor whose rotor is produced from an injection-moldable plastic material.

DE 295 20 95 A1 describes the use of plastic material for the motor housing wherein preferably motor parts such as stator windings and return element are injected into or bonded to the housing as inserts or they are connected to it firmly via snap-lock or crimp connections.

### SUMMARY OF THE INVENTION

As technical development is increasing, the demand for compact but efficient and reliable electric motors which can be produced cheaply in particular in a power range of several Watts to several hundred Watts has increased considerably. Such electric motors have increasingly been used for instance as servomotors and also as drive units in numerous technical fields, in particular in automotive manufacturing, and conquer new areas of application and functions which did not exist before or were not electrically driven. For this reason, the demand for compact, reliable electric motors which can be produced cheaply will continue to rise.

By way of contrast, the task of the present invention is to develop further a brushless electric motor in an appropriate manner such that the motor meets the aforementioned requirements and to provide an electric motor which is especially compact, reliable and can be produced at a reasonable price as well as to provide a housing for such a brushless electric motor and a method of producing such a brushless electric motor.

These tasks are inventively solved by the subject matter of claims 1 and 2 and 16. Advantageous developments may be taken from the subclaims.

According to the invention it is favorable that in these motors the wall thickness of the housing—except for possibly embedded reinforcement or form fit elements or connection areas—can be reduced significantly. This results, in addition to the weight advantage, in a further significant reduction in weight compared to conventional metal housings due to the lower specific density of the plastic material. At the same time, such a housing is provided with a high resistance to corrosion in particular when it comes to weather effects and salts.

Up to now, it has been difficult to provide plastic housings with the necessary stability which resulted in particular in a high material input for the housing (use of thick walls) and in increased production costs and weight. In addition, the temperature range for the use of such housings was strongly limited and motor cooling through the wall of the housing was hindered by the increased wall thickness of the housings which conducted heat more poorly.

Surprisingly, the inventive construction makes possible a very good heat transfer from the stator assemblies to the outside in particular due to the low necessary wall thickness and in this way makes possible a good removal of motor power loss, even in motors in the kilowatt power range which are operated continuously, and as a result a reliable cooling of the motor—in particular of the stator windings.

With the help of the invention, surprisingly enough, a considerable further reduction in noise development within the housing and in noise transfer through the housing to the outside and as a result in noise emission as airborne sound was achieved and at the same time the transfer as body-borne noise to adjacent elements and an outstanding vibration dampening was provided. A further advantage is a certain tolerance with respect to fit and adjustment inaccuracy which can be taken up by the inventive housing and balanced.

In addition, the inventive housing achieves an improved dimensional stability and loadability due to its pre-loaded construction and the mutual reinforcement of the housing elements which are pre-loaded against each other as well as among each other with reference to the stator assembly and can maintain these advantageous properties via a large temperature range, for instance between −50 C° and +80 C° of ambient temperature (depending on the plastic material used).

But still the housing is provided with a certain degree of flexibility over the entire temperature range which makes possible flange connections or clamped connections, for instance compared with fastening constructions made of metal, without the use of compensatory elements. Furthermore, accelerations and vibrations of autochthonal (for instance through the operation of the fan unit) as well as of allochthonal (for instance through the operation of the vehicle) type are eliminated ideally due to the elasticity intrinsic in the design of the housing.

At the same time the assembly of functional and drive components of the brushless electric motor and their incorporation into the inventive housing can be implemented especially easily and cheaply all the way through the entire production and manufacturing process as the complexity and the number of components of such a motor is reduced and can be adjusted very well to machine workflows.

Advantageously, in particular hybrid plastic materials with high-strength solid components which are embedded into the plastic matrix are used as housing materials in order to increase mechanical stability in pressure, tensile and torsion loads as well as to improve the heat conductivity of the housing. As solid components preferably solid particles or fibers (for example glass or carbon fibers) which can be oriented arbitrarily or optimized corresponding to the main load directions are embedded in a matrix made of thermoplastic, in particular injection-moldable plastics material such as polyimide, polypropylene, polycarbonate, polybuthlenterephthalat or similar materials. Processing and shaping of the components can therefore be carried out as a compound in a one-component injection molding process, in a two-component injection molding process or in an insert molding process.

The inventive housing consists of a case section which is preferably substantially of a cylindrical shape and which can also be provided with other polygonal cross-sections such as square, hexagonal, octagonal, dodecagonal. When fully assembled, this casing section is covered by one cover section each at both end sections wherein each of the cover sections receives a bearing for the armature shaft. Moreover, the housing is also provided with the at least one molded body which extends between the casing of the housing and the armature and serves to receive the stator assembly while at the same time determines mechanically the axial and radial position of the stator assembly.

All of the above mentioned components can be produced separately and for instance be connected to each other positively and/or bonded to each other firmly during assembly or they can partially be produced integrally in one single injection molding process. At least one of the two cover sections is not connected integrally to the necessary drive and functional components of the motor for assembly, but is connected positively or bonded firmly to the casing section of the housing after installment of the above mentioned components.

In an advantageous embodiment, at least one of the two, preferably both cover sections can be produced separately from the casing section of the housing and can be mechanically connected to it This makes possible, among other things, use and interchangeability of the bearing of the armature shaft, exchanging of drive and functional components within the housing as well as a simplified assembly process.

In a further advantageous development the bearing can be provided with roller bearings, in particular ball bearings, which are integrally connected to the cover sections, preferably by (integral) injection molding during the manufacturing process of the cover sections. Hereby, the bearings can comprise in particular lubricators and sealing devices, in a conventional way. This embodiment makes possible a particularly reliable connection between the bearings and the cover sections of the housing which carry the bearings which, for instance, makes almost impossible a loosening of the bearing seat even after it has been used for a long time. Furthermore, this embodiment can be produced especially cheaply.

In a further advantageous development the bearing can be provided with roller bearings, in particular ball bearings, which are positively connectable, in particular lockable to the cover sections—in particular via clip connections. In this design it is advantageous that, during final assembly, bearings are chosen depending on the technical requirements and that they can be reliably connected to cover sections and that, if necessary, bearings can be exchanged subsequently.

In a further advantageous development at least one of the cover sections can be positively connected, in particular locked in place, to the casing section of the housing, in particular via one or several clip connections, preferably in a free-from-play manner. This allows for an especially easy and cheap final assembly of the brushless electric motor which can be carried out by a machine and also by hand and which, in this way, makes possible to equip the electric motor individually with constructional elements corresponding to the technical requirements specification. With the help of pre-loaded snap-in tongues or detests the cover sections can easily be clipped onto the casing section and is this way be easily connected to the casing section.

In a further advantageous development at least one of the casing sections can be connected positively to the casing section of the housing, preferably via adhesive bonding and/or welding. This results in an especially loadable connection absolutely free from play between the respective sections which can further be tamper-proof in order to, for instance, prevent third parties from intervening with the machine.

According to a further advantageous development at least one of the cover sections can be pre-loaded in a radial direction at least in the assembled state relative to the casing section of the housing. In this way, any mechanical play and as a consequence wear can be avoided and an unrestricted flow of power via the housing components can take place and a reinforcement of the housing can be achieved. Furthermore, this pre-loaded design allows for the use of the brushless electric motor via a broad range of the operating temperature and under mechanical alternating and vibrational loads.

According to a further advantageous development at least one of the cover sections forms a taper seat with the casing section which builds up a radial preload between the respective cover section and casing section during assembly wherein the respective cover section may further be provided with a stop in the proximal direction relative to the casing section; this design ensures a free-from-play connection of the elements and in this way allows for an undisturbed flow of power as well as the reinforcement of the housing which can be ensured respectively via large ranges of temperature. Hereby, the radial pre-load is automatically built up during assembly of the cover between the cover section and the casing section of the housing. In addition, in proximal direction an axial stop can be provided which can ensure a defined stop position during assembly and in this way an exact orientation and positioning of the cover section relative to the casing section. By using respective profiles with rounded edges and transition regions notch loads can be minimized.

In a further advantageous development the housing can be provided with reinforcement elements which in particular extend in an axial direction. This allows for a high mechanical loadability of the housing in spite of the use of the advantageously low wall thickness of the housing and for a reliable flanging of the motor housing without the necessity of providing additional fixing elements whereas the axial positioning of the motor housing can be flexibly changed. In addition, such a design allows for or improves the use of non-cylindrical casing sections, which can, for instance, be provided with a polygonal cross section (in particular square, hexagonal, octagonal, dodecagonal). As a result, installation space can be saved in addition and the motor housing can be made more compact which makes possible higher power densities while at the same time cooling is improved, too.

According to a further advantageous development the casing section of the housing can be provided on its inner surface with, in particular raised, preferably ring-shaped receiving structures for the at least one molded body wherein—in particular in the state of final assembly—a radial preload between the at least one molded body and the casing section of the housing is produced. Such a design is especially favorable when it comes to construction and assembly and allows for a good transmission of power and a high loadability of the housing construction.

In a further advantageous development the casing section of the housing can be firmly bonded to the at least one molded body, preferably by integral manufacturing or via adhesive bonding and/or welding. In this way, lose components can be reduced which is favorable for assembly. Moreover, an especially loadable, free-from-play connection between the at least one molded body and the housing is produced which further increases the loadability of the housing construction.

In a further advantageous development the housing components, in particular cover sections and/or casing section and/or molded bodies can be available in different dimensions similar to a modular construction system, as a result of which a plurality of different assemblies of housing components in different dimensions depending on the technical requirements of the electric motor to be produced is available. Using such an embodiment makes possible to provide for a plurality of motors with only a limited range of housing components which can be produced easily and these motors can be adapted ideally to their future purpose in view of their power, design and/or other technical data and can be produced flexibly and cheaply.

In a further advantageous development in particular the cover sections can be provided with venting slots for cooling the drive components, in particular the stator assembly. In addition, motors with a relatively high power input and relatively long duty cycles can be provided with a forced cooling via an air supply unit which is driven by an armature shaft and can, in particular, be used for cooling the stator assembly especially effectively. In this way, cooling the motor can be further improved in addition to the heat dissipation via the housing surface and in particular the temperature of the stator windings can be reduced which makes possible a higher power density of the motor while the construction size is reduced at the same time. Furthermore, the necessity of the transmural heat transfer via the motor housing has to be taken into account only slightly or not at all.

Further advantages, details and features may be taken from the following description of embodiments of the invention in connection with the figures. Hereby, the different features of the subclaims as well as the features described in the embodiments—obvious to somebody skilled in the art—can be combined with each other freely unless they exclude each other technically.

### BRIEF DESCRIPTION OF THE FIGURES

FIG. 1 shows an oblique view of a brushless electric motor with a housing from the “right” side with an integrated first cover section according to a first embodiment;

FIG. 2 shows an oblique view of a brushless electric motor with a housing from the “left” side with a snapped-on second cover section according to a first embodiment;

FIG. 3 shows the medial section of a brushless electric motor with housing according to a first embodiment;

FIG. 4 shows an exploded view of a brushless electric motor with housing according to a second embodiment, and

FIG. 5 shows an oblique view of housing of the brushless electric motor opened on one side according to the second embodiment in the assembled state with built-in functional components.

### DETAILED DESCRIPTION

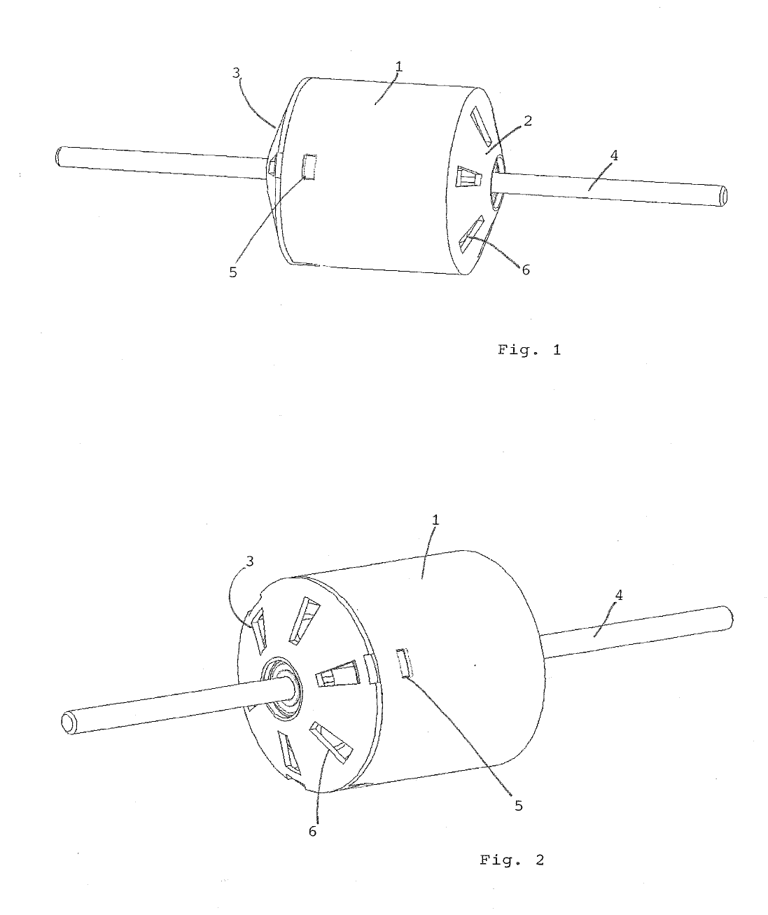

FIGS. 1 and 2 show oblique views of a brushless electric motor with housing according to a first embodiment from two different perspectives. This is an embodiment in which the housing is provided with a first cover section 2 which is integrally adapted to the casing section I as well as a second cover section 3 locked in place. The armature shaft is provided with reference number 4 and passes through both sides of the housing. Furthermore, the locking openings 5 can be seen in the casing section 1 of the housing; the snap-in tongues of the snapped-in cover section 3 which are not displayed in these figures form a positive connection with the locking openings. Both cover sections 2 and 3 are provided with six venting openings each for cooling, in particular, the current-carrying stator assembly (not shown) of the brushless electric motor.

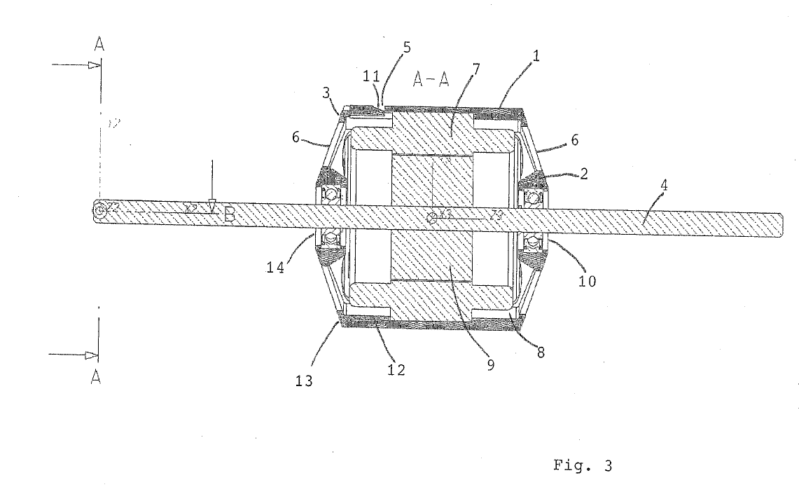

FIG. 3 shows a cross-sectional view of this brushless electric motor according to the first embodiment. The casing section I of the housing surrounds the stator assembly 7 in a play-free manner which is stabilised by the molded bodies 8 and maintained in position axially as well as radially. The armature shaft 4 carries the rotor 9 which rotates in the stator and is provided with permanent magnets. In this Fig. on the right-hand side, the casing section 1 is covered by the injection molded first cover section 2 which is provided with venting openings 6. Injection molded into this cover section 2, a first ball bearing 10 is located for mounting the armature shaft 4. Displayed on the left side of the embodiment is the second cover section 3 with venting openings 6 which is connected to the casing section 1 of the housing via snap-lock connections 5, 11. These snap-lock connections are formed by the snap-in tongues 11 which are locked in place with the recesses 5 in the casing section 1 of the housing. The second cover section 3 which can be snapped-in forms a taper seat 12 with the casing section 1 of the housing through which the cover section 3 is pre-loaded in a radial direction relative to the casing section 1 of the housing. Furthermore, the cover section 3 is provided with a flange section 13 which, in connection with the snap-in tongues 11, maintains the cover section 3 in position in a radial direction, exactly and free-from-play. Moreover, the cover section 3 which can be snapped-in is also provided with an injection-molded ball bearing 14 which mounts the armature shaft 4 in connection with the ball bearing 10 within the housing in a rotary way.

As an option, the lockable cover section 3 can additionally be bonded firmly to the casing section 1 with the aid of a suitable adhesive.

Furthermore, it is possible to provide a fan (not shown) on the armature shaft 4 as an air supply unit for improving the circulation of air through the venting openings 6 for cooling the stator assembly. Typically, the brushless electric motor is provided with at least three part-windings on the stator assembly. This number of part-windings can, for instance, be increased to six part-windings in order to achieve an operating performance which is reduced in noise and vibrations and/or to increase the maximum torque of the motor. In this embodiment the housing material consists preferably of glass-fiber reinforced polyamid. Furthermore, it is possible to keep ready housing components and functional components in different sizes in order to be able to provide, similar to a modular construction system, a plurality of different brushless electric motors for various performance requirements and areas of application, in a simple and flexible way. The control electronics of the motor can either be placed in a separate housing independently of the motor or in the motor housing. Hereby it can make sense to locate the control electronics, in particular for motors with a relatively high power. in particular with several hundred Watts, in the air flow of the forced ventilation.

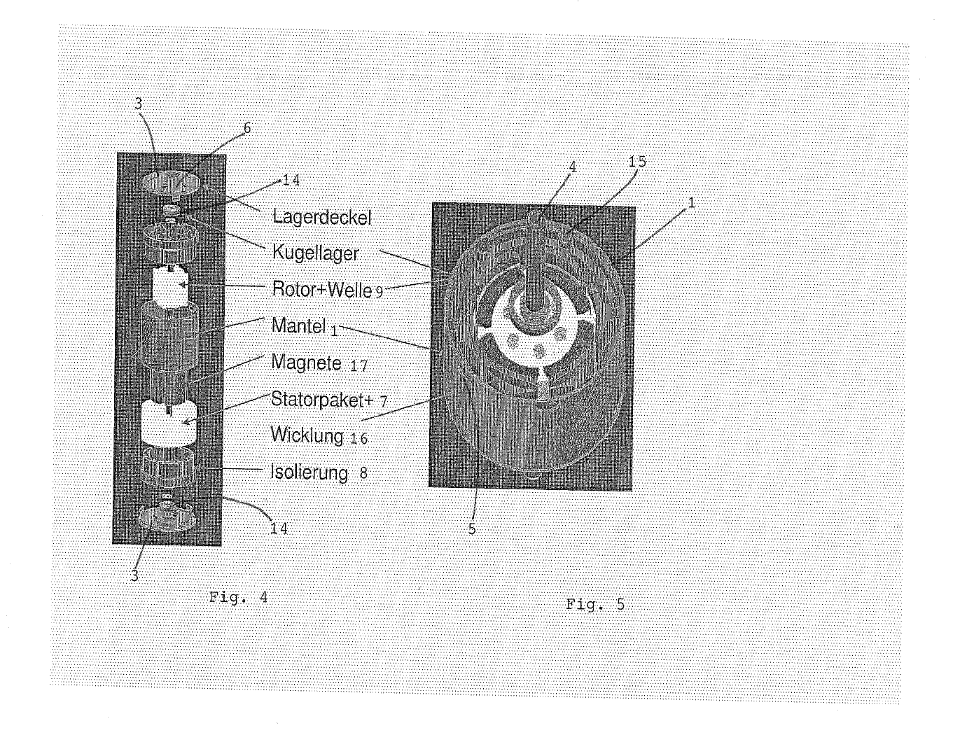

FIG. 4 is an exploded view of a brushless electric motor according to a second embodiment. This embodiment is provided with a casing section 1 onto which lockable cover sections 3 can be snapped-in on both sides. The motor, in turn, is provided with an armature shaft 4 to which the rotor 9 with the permanent magnets 17 is attached. As shown, the stator assembly 7 with the windings 16 surrounds the rotor and, when fully assembled, meshes with the molded bodies 8 and keeps them in position axially as well as radially.

Reference number 14 represents both ball bearings which, when fully assembled, are connected to the respective cover section 3 via a snap-in connection. The casing section 1 is provided with recesses 5 which, when fully assembled, are connected to the snap-in tongues 11 of the cover sections 3 via a snap-in connection. Furthermore, the casing section 1 is provided with structural elements 15 in the form of axially extending ribs which serve as reinforcement elements of the housing on the one hand and, on the other hand, keep the molded bodies 8 in position with the stator assembly 7, safe against rotation.

Casing section 1 as well as structural elements 15 are designed in such a way that together with the molded bodies 8 they form a press fit during assembly and build up a radial pre-load between the molded bodies 8 and the casing section 1 of the housing and in this way—together with the stator assembly 7—allow for a mutually reinforcing housing construction. Likewise, the locking of the cover sections 3 and the taper seat produce a radial pre-load relative to the casing section 1 of the housing and at the same time an axial pre-load between the molded bodies 8 and the cover sections 3.

What is claimed is:

1. Brushless electric motor—preferably for a vehicle fan—having an armature (9) which is supported on both sides in a housing,
wherein the housing consists substantially of a plastic-containing material,
and which is provided with a casing section (1).
as well as two cover sections (2, 3),
onto or into both cover sections (2, 3) one bearing (10, 14) each being formed for the armature shaft (4),
and said two cover sections (2, 3) being connected to each other via the casing section (1) and being supported by each other,
and which is provided with a stator assembly (7) which extends between the housing casing section (1) and the armature (9), characterized in that the housing is provided with at least one molded body (8) consisting of a plastic-containing material for receiving the stator assembly (7) while at the same time determining its axial and radial position,
said at least one molded body (8) in turn being clamped between the cover sections (2, 3) and the casing section (1) in radial and axial direction, and in this way reinforcing the housing.

2. The invention as claimed in claim 1, wherein a housing is provided, and where the at least one molded body (8) is located between the casing section (1) and the armature (9).

3. The invention as claimed in claim 1, in which at least one of the two, preferably both cover sections (2, 3) are manufactured separately from the casing section (1) of the housing and they are mechanically connected to it.

4. The invention as claimed in claim 1, in which the bearings are provided with roller bearings, in particular ball bearings (10, 14), which are integrally connected to the cover sections (2, 3) preferably by (integral) injection molding during the manufacturing process of the cover sections (2, 3).

5. The invention as claimed in claim 1, in which the bearings are provided with roller bearings, in particular ball bearings (10, 14), which are positively connected, in particular locked in place, to the cover sections (2, 3), in particular via a clip connection.

6. The invention as claimed in claim 1, in which at least one of the cover sections (2, 3) is positively connected, in particular locked in place, to the casing section (1) of the housing, in particular via one or several clip connections, preferably in a free-from-play manner.

7. The invention as claimed in claim 1, in which at least one of the cover sections (2, 3) is provided with further form fit elements which interlock with corresponding form fit counter-elements of the casing section (1) of the housing, preferably in a free-from-play manner.

8. The invention as claimed in claim 1, in which at least one of the cover sections (2, 3) is firmly bonded to the casing section (1) of the housing, preferably via adhesive bonding and/or welding.

9. The invention as claimed in claim 1, in which at least one of the cover sections (2, 3), at least in the assembled state, is provided with a radial preload relative to the casing section (1) of the housing.

10. The invention as claimed in claim 1, in which at least one of the cover sections (2, 3) forms a taper seat (12) with the casing section (1) said seat building up a radial preload between cover section (3) and casing section (1) wherein preferably the cover section (3) is provided with a stop (13) in proximal direction relative to the casing section (1).

11. The invention as claimed in claim 1, in which the housing is in particular provided with structural reinforcement elements (15) in the form of axially extending ribs.

12. The invention as claimed in claim 11, in which the structural reinforcement elements (15) are located on the inner surface of the casing section (1) of the housing, and are, in particular raised and preferably rib-shaped, and function as receiving structures for the at least one molded body (8), and which—in particular in the state of final assembly—produce a radial preload between the at least one molded body (8) and the casing section (1) of the housing.

13. The invention as claimed in claim 1, in which the casing section (1) of the housing is firmly bonded to the at least one molded body (8), preferably by integral manufacturing or via adhesive bonding and/or welding.

14. The invention as claimed in claim 1, in which housing components, in particular cover sections (2, 3) and/or casing section (1) and/or molded body/bodies (8) are available in different dimensions similar to a modular construction system as a result of which a plurality of different assemblies of housing components in different dimensions depending on the technical requirements can be produced.

15. The invention as claimed in claim 1, in which the cover sections (2, 3) are provided with venting slots for cooling, in particular for forced cooling via an air supply unit which is driven by an armature shaft, in particular of the stator assembly (12).

16. Method of producing a brushless electric motor—in particular for a vehicle fan—which consists of the following steps:
producing a housing;
having an armature (9) which is supported on both sides in the housing, wherein the housing consists substantially of a plastic-containing material, and which is provided with a casing section (1), as well as two cover sections (2, 3),
introducing one bearing (10, 14) each into the two cover sections (2, 3);
introducing at least one molded body (8) for receiving a stator assembly (7) in the casing section (1);
introducing the stator assembly (7) into the at least one molded body (8);
introducing an armature shaft (4) with an armature (9) into the casing section (1) with the at least one molded body (8) and the stator assembly (7);
assigning of the armature shaft (4) with the armature (9) as well as the casing section (1) and the cover section(s) (2, 3);
positively connecting or firmly bonding—preferably by locking into place—the cover section(s) (2, 3) to the casing section (1) wherein a preload in a radial and axial direction between the cover section, casing section (1), molded body/bodies (8) and/or stator assembly (7) is built up as a result of which a housing is formed which is reinforced in an axial and radial direction.
